(19) United States
(12) Patent Application Publication
(10) Pub. No.: US 2024/0358476 A1
(43) Pub. Date: Oct. 31, 2024

(54) ORTHODONTIC APPLIANCES, SYSTEM AND METHOD OF PRODUCING AND USING THE SAME

(71) Applicant: ArchForm, Inc., Sunnyvale, CA (US)

(72) Inventors: Martin Martz, Sunnyvale, CA (US); Andrew Martz, Sunnyvale, CA (US)

(21) Appl. No.: 18/687,733

(22) PCT Filed: Aug. 28, 2022
(86) PCT No.: PCT/US2022/041784

§ 371 Date: Feb. 28, 2024

Related U.S. Application Data
(60) Provisional application No. 63/238,107, filed on Aug. 28, 2021.

(51) Int. Cl. A61C 7/08; A61C 8/00; A61C 13/00

(52) U.S. Cl. CPC A61C 7/08; A61C 8/0096; A61C 13/0006

(57) ABSTRACT

Orthodontic appliances, systems and methods of producing and using the same are provided. A dental appliance is a unibody aligner with a top surface and a bottom surface. The unibody aligner includes an alignment portion shaped to fit over multiple teeth of a patient with the alignment portion having a buccal side and a lingual side. The unibody aligner includes a palatal portion integrally formed with the lingual side of the alignment portion. The palatal portion including one or more retention sockets with each of the one or more retention sockets shaped for fitment over an implanted temporary anchorage device (TAD).

### CROSS-REFERENCE TO RELATED APPLICATIONS

This application is a non-provisional application and claims the benefit of provisional U.S. Patent Application No. 63/238,107 filed Aug. 28, 2021, which is hereby incorporated by reference in its entirety.

### BACKGROUND

Therapeutic dental appliances may be used in the treatment of various dental conditions. Non-limiting examples of therapeutic dental appliances include orthodontic appliances, such as orthodontic aligners and orthodontic retainers, and splints, such as surgical splints and occlusal splints. Therapeutic dental restorations are used by patients for many reasons, including to improve or restore function, to aesthetically improve a patient's dentition, to reduce wear on teeth, and to treat joint pain and other medical conditions.

For example, orthodontic aligners are used to reposition teeth or retain teeth in a current position during orthodontic treatment. Orthodontic aligners may include a thin shell (usually formed from a clear plastic material) that closely follows the contours of a patient's teeth. It should be noted that the terms aligner, positioner, and tooth-positioning appliance are largely synonymous as used in the orthodontic field. Some implementations include separate maxillary and mandibular aligners. The tooth-positioning appliances fit over the teeth, covering at least some of the facial and lingual surfaces of some or all of the teeth, and often at least some of the occlusal (or biting surfaces) of the teeth.

### SUMMARY

In general terms, this disclosure is directed to orthodontic appliances, system and method of producing and using the same.

The details of one or more aspects are set forth in the accompanying drawings and description below. Other features and advantages will be apparent from a reading of the following detailed description and a review of the associated drawings. It is to be understood that the following detailed description is explanatory only and is not restrictive of this disclosure.

### BRIEF DESCRIPTION OF THE DRAWINGS

FIGS. 1A-1E are schematic diagrams of example TADs with spherical heads in accordance with embodiments described herein.

FIGS. 2A-2D are schematic diagrams of example aligners and dental models for forming aligners in accordance with embodiments described herein.

FIGS. 3A-3F are schematic diagrams of example shapes other than spheres that may be included in some embodiments to support aligner anchorage and other attachment methods, such as attaching these other shapes to plates attached to TADs inserted into the palatal bones.

FIGS. 4A-4C are example TADs and aligners in a patient's mouth in accordance with embodiments disclosed herein.

FIGS. 5A-5H are schematic diagrams of various examples of 3D printed dental models with TADs or TAD analogues embedded therein and examples of aligners with recesses configured to mate with the TADs.

FIGS. 6A-6D show schematic diagrams of bone plate attachment tubes and aligners that are shaped to engage with those bone plate attachment tubes.

FIGS. 7A-7E are schematic diagrams showing a series of aligners that are performing sequential (serial) distal movement or mesial movement of upper or lower teeth in accordance with embodiments described herein.

FIGS. 8A-8E are schematic diagrams showing a series of aligners that are performing sequential (serial) distal movement or mesial movement of upper teeth in accordance with embodiments described herein.

FIGS. 9A-9B are schematic diagrams of embodiments of aligners with reinforcing structures in accordance with embodiments described herein.

FIG. 10 is a schematic diagram of a cross-sectional view of an embodiment of a dental model with a hole to allow more complete thermoforming to an analogue TAD structure in accordance with embodiments described herein.

FIGS. 11A-11C are schematic drawings of an embodiment of a metallic double loop wire in accordance with embodiments described herein.

FIG. 12 is a schematic diagram of curved closed metallic loops on the palatal side of upper aligner appliances that can serve as active elements to achieve efficient mesial or distal movement of individual teeth in accordance with embodiments described herein.

FIGS. 13A-13B illustrate embodiments of aligners with hinged arm elements with active elements for distal movement of posterior teeth (molars) in accordance with embodiments described herein.

FIGS. 14A-14D illustrate embodiments of aligners that couple to TADs in accordance with embodiments described herein.

FIGS. 15A-15C are schematic diagrams illustrating a CAD-based process to adjust the contours of digital teeth in appliance-forming models to increase appliance retention in accordance with embodiments described herein.

FIG. 16A shows an embodiment of a 3-D printed palatal covering layer to be used as a reinforcing layer for an aligner in accordance with embodiments described herein.

FIG. 16B shows the same 3-D printed palatal covering layer of FIG. 16A with a thermoformed clear plastic layer that has been formed over the top of it.

FIG. 16C is a modification of the same picture shown in FIG. 16B.

FIG. 16D shows an embodiment of a dental appliance as described herein.

FIG. 16E shows an embodiment of a dental appliance of described herein.

FIG. 17 is a schematic diagram of a dental model with three cylindrical TAD analogues positioned in the palate in accordance with embodiments described herein.

FIG. 18 shows an example of a computer device that can be used to in the design and fabrication of the dental appliances described herein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the technology disclosed herein.

The present disclosure relates to fabrication of dental appliances that are usable to provide therapy to a patient. In particular, the present disclosure relates to fabrication of orthodontic appliances such as orthodontic aligners. In some implementations, the orthodontic aligner may be part of a series of removable orthodontic aligners to reposition a patient's teeth over time. The technology can be used to fabricate the appliance fully or partially within an office of a medical professional.

In some implementations, orthodontic positioners (or aligners) are made from a set of plaster models derived from three-dimensional (3D) negative dental impressions of a patient's teeth. The plaster dental models are then modified by cutting the teeth apart using a small jeweler's saw or rotary cutting discs, followed by repositioning the plaster teeth in a better, straighter, desired arrangement, and then holding the teeth in the new arrangement with dental wax.

The repositioned teeth molds provide the basis for manufacturing the positioners. The resilience of the material from which the positioner is made provides the energy to move the teeth from their original position toward the new straightened position. A series of aligners may be made to move the teeth in incremental steps. Making a series of appliances is difficult, time-consuming, and error-prone when the tooth arrangement for each step must be made by hand using plaster and wax.

Digital technologies can be used to overcome at least some of the difficulties associated with fabricating a series of aligners that move teeth incrementally. Computer Aided-Design (CAD)/Computer-Aided Manufacturing (CAM) software can be used to produce tooth models, from which a progressive series of appliances can be manufactured. The tooth models can be generated from 3D images of the patient's dentition. These tooth models can then be repositioned and used to form aligners. For example, the repositioned tooth models can be used to fabricate dental models upon which aligners are formed from a sheet of material, such as clear plastic material, using a combination of vacuum, pressure, and heat. This forming process is informally referred to within the orthodontic laboratory community as the “suck down” process.

In one process for producing a series of aligners, a technician first scans a patient's dental model to obtain CAD-manipulatable virtual models of a patient's dental anatomy. A dental model normally consists of one upper and one lower plaster model of the teeth, palate, and gums. Once the virtual model of the original malocclusion has been obtained, a technician will then undertake steps involving extensive manipulation of the virtual malocclusion. This involves extensive repositioning of the teeth according to a comprehensive and sequential procedure, ultimately arriving at a finished or ideal occlusion for that patient. The finished occlusion in the virtual model is consistent with the complete repositioning of the patient's upper and lower occlusion that would result at the end of successful conventional orthodontic treatment. After the steps described above are accomplished, the technician possesses two versions of the patient's teeth available within the virtual CAD environment. One version represents the original malocclusion and the other represents the ideal occlusion. In other words, the technician has models representing the beginning and end states of the patient's teeth.

Another step in the process involves the creation of an incremental, progressive series of physical forming models. Each of these forming models represents a snapshot of the patient's future occlusion at specific incremental steps along the patient's proposed treatment sequence between the beginning and the end conditions as described above. To accomplish this, the technician creates a virtual first transition model. This virtual first transition model represents some or all of the teeth being subtly moved from their original pre-treatment positions to a virtual first transition position that is in the direction of their intended finished positions. Additional virtual transition models can be created similarly. In this manner, the technician creates a series of progressive models, with each biased slightly further than the previous one, and each moves the teeth slightly closer to their finished target positions. A final forming model will take the teeth from the series of transition positions and move them into their final, desired positions. Some embodiments of the models may be entirely 3-D printed using suitable printing materials or compositions.

Once such a series of virtual intermediate forming models has been created and a final forming model has been created by the technician, digital code representing each of the models in the series is directed to operate a rapid prototyping machine. Within a rapid prototyping machine, the series of physical forming models are produced using any of a number of conventional processes, such as computer numerically-controlled (CNC) machining, stereo lithography, or 3D printing. The production step results in the production of hard, physical models that correspond to each of the series of virtual intermediate models and the final model.

In another step of the process, each of the series of physical models is mounted in a vacuum machine (also referred to as a suck-down machine) where a combination of pressure, heat, and vacuum is used to form the actual series of progressive aligners from plastic sheet material of a constant thickness. Once the series of progressive aligners are formed and trimmed, they are sequentially labeled, packaged, and shipped (e.g., to the attending orthodontist or patient). The orthodontist may then schedule an appointment for the patient, at which time the aligners and instructions for their use are given to the patient. The patient is instructed to wear the first set of aligners for a period of time, typically two weeks. After that, the first set is discarded and the patient transitions to the next set of the series and so on.

The aligners can be configured to urge the patient's teeth to move according to the positional biases created virtually by the technician. The teeth are progressively biased and urged to move in desired directions toward their predetermined finished positions by the resilience of the polymeric material of the aligner. Ideally, gentle but continuous forces would be delivered by the aligners, causing certain physiological processes involving the creation and/or restoration of the bone supporting the roots of the teeth to take place. The net result should be the slow, progressive orthodontic movement of the roots of the teeth through the underlying bone toward desirable positions and orientations.

Embodiments of the appliance described herein may include a single aligner or one or more aligner from a series of aligners. Some embodiments do not include an aligner, but instead include one or more bands, bars, or brackets that are coupled to the patient's dentition.

Some embodiments include temporary anchorage implant devices or temporary anchorage devices (TADs). The TADs may be used to secure an aligner in a specific orientation with respect to the patient's dentition. The TADs may have a round, partially or fully spherical head. The TAD may be used in, for example, the palate or mandibular buccal shelf to directly engage aligners.

Some embodiments of the aligners include palatal coverage by the upper aligner or partial palatal coverage by the upper aligner. The aligners may include molded recesses to directly engage the head of the TADs. For example, the aligners may include rounded recesses that are shaped to mate with the heads of one or more TADs.

Some embodiments include components that can be attached to existing TAD devices to engage aligners to the palate. For example, the aligners may include recesses shaped to fit over the outer surfaces of the components that are attached to the TAD devices.

Some embodiments include aligners that include partial coverage of gum tissue on the facial side of upper and lower aligners to engage a fixed device such as a TAD implanted in the patient's mandibular buccal shelf.

Some embodiments include aligners having molded recesses that are shaped to directly engage existing bone plate attachment tube designs. These aligners may be designed using a computer-aided-design (CAD) system.

Some embodiments include a series of aligners to perform a sequential serial distal movement or mesial movement of upper or lower teeth. For example, an aligner may move one tooth at a time.

Some embodiments include modified aligner outlines or shapes and components that provide active elements to cause tooth movements. The aligners may also include formed reinforcing structures that are positioned, sized, and shaped to decrease the likelihood of the aligner flexing in specific directions when under certain loads.

Some embodiments include dental models that have passages that allow air flow passages to improve the abilities of vacuum and air-pressure thermoforming machines to form around undercuts. These air flow passages may be positioned, for example, near analogues of the TADs in the dental models. These passages may prevent or minimize air being trapped in the area around the TAD analogues and consequently interfering with the vacuuming forming of the shapes.

Some embodiments include heat-treated metallic double loop elements to achieve space opening and space closure more efficiently. In some embodiments, curved closed metallic loops may serve as active elements on the palate to achieve more efficient mesial or distal movement.

Some embodiments include hinged arm elements that have active elements for distal movement of posterior teeth (molars). In some implementations, multiple hinged arm elements are used sequentially to perform sequential distal or mesial movements.

Some embodiments of the aligners are formed from a digital model that includes tooth contour modifications to increase appliance retention.

Some embodiments include layers of aligner materials that provide increased strength in selected areas. For example, some aligners may include a palatal layer as a reinforced central platform to engage TADs and provide support for hinge points for pivoting arms and elastic members. Additionally or alternatively, some implementations include buccal support layers that tightly engage buccal attachments on teeth for rigid anchorage. Some implementations may also include buccal support layers that provide support for rotational axles to support inter-arch appliances. Some implementations may include lingual support structures to control molar tipping, prevent molar tipping, and to control changes in posterior arch width.

Computing devices may be configured to generate three-dimensional digital models that represent the aligners of tooth models upon which the aligners are formed. The computing devices may, for example, store instructions that when executed by a processor in the computing device may perform methods for generating digital representations of at least some of the aligner and tooth models described herein.

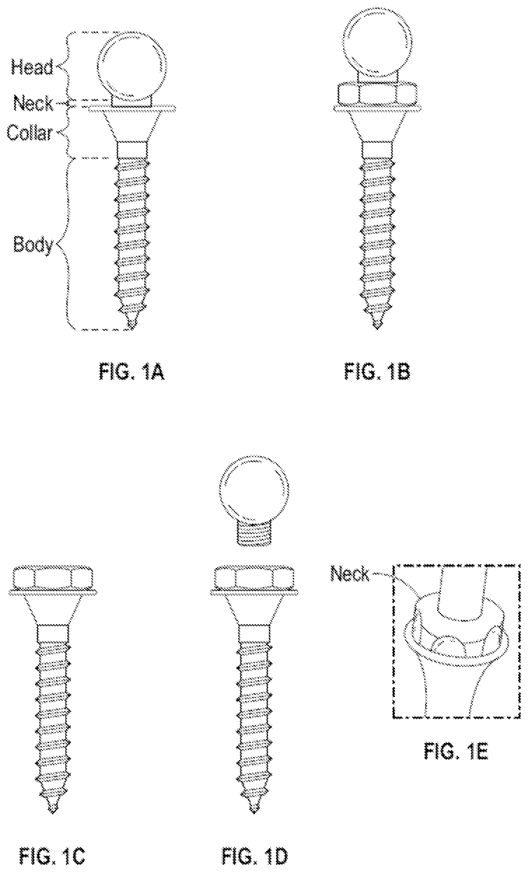

FIGS. 1A-1E are schematic diagrams of example TADs in accordance with embodiments described herein. FIG. 1A shows an embodiment of an example TAD with a threaded body, a tapered collar with a flared flange at the gingival margin, a thinner neck, and a spherical head. The spherical head may have a diameter of approximately 2-5 millimeters, with an ideal range being 2.5-3 millimeters. Also, other diameters may be used. Embodiments of this TAD may include a drive hole in the top of the head to receive a driver (not visible from this view).

FIG. 1B shows an embodiment of an example TAD with a threaded body, a tapered collar with a flared flange at the gingival margin, a driver engagement section with a larger diameter than the head, a thinner neck, and a spherical head. At least some implementations of the embodiment of the TAD may not include a drive hole in the top of the head. although that is optional as a redundant feature. In at least some implementations, the radius of the spherical head is less than the width of the driver engagement section to allow a socket wrench to fit over the spherical head and engage with the driver engagement section. In this example, the driver engagement section has a hexagonal perimeter. In some embodiments, the driver engagement section has a different shape. For example, the driver engagement section may be hemispherical with hemispherical cutouts as shown in the example neck of a TAD in FIG. 1E. Beneficially, the shape of the driver engagement section shown in FIG. 1E may provide more strength and may be less likely to strip than a hexagonal shape.

FIG. 1C shows an embodiment of an example TAD with a threaded body, a tapered collar with a flared flange at the gingival margin, and a driver engagement section. This variation is designed to be a two-piece TAD and this segment is the portion that penetrates the bone and is the main supporting element. It has a threaded hole in the center of the top surface designed to receive another portion of the TAD. There are several two-piece TAD systems already available in the commercial dental marketplace.

FIG. 1D shows an embodiment of the example TAD of FIG. 1C with a second portion that has a spherical head shape and a threaded neck portion designed to fit into the threaded hole in the top of the first portion of the TAD. Embodiments of this TAD may include a drive hole in the top of the head to receive a driver (not visible from this view).

The TADs shown herein may be used to couple an aligner to a patient's dentition. For example, the TADs may be placed in a patient's palate and the aligner may fit over and engage with the TADs. The aligner may be designed (as described further elsewhere herein) to engage with the TADs to apply a force to the reposition teeth. Beneficially, the embodiments of the TADs that include spherical shaped heads do not require that the TADs be placed in a parallel manner for engagement with the aligners. However, some embodiments may include TADs with different head shapes as well. For example, some embodiments include TADs with flattened sphere shapes, or other shapes such as a sphere, cylinder, ellipsoid, ovoid and pyriform.

Embodiments of the TADs may also include various shapes for the driver engagement portion. As shown in FIGS. 1B-1D, the driver engagement portion may include a hexagonal perimeter. Other regular polygon shapes are possible too. For example, some embodiments may include a four-sided regular polygon (a square) shaped driver engagement portion. Embodiments with four sides (faces) rather than six may allow for greater strength and more bulk for the corners, making them less likely to become damaged when being tightened.

As shown in FIG. 1E, some embodiments include driver engagement portions having different shapes that are not regular polygons too. The shape of the drive engagement portion can also vary considerably. For example, the driver engagement portion may have multiple sides (faces) with semicircular recesses (bites) removed from the middle of the faces. These recesses may provide deeper cutout areas for engagement with a driver while also leaving bulkier areas of material at the corners for increased strength, to minimize the possibility of the engaging socket wrench “stripping” away the corners of the driver engagement portion of the TAD. In at least some embodiments, the entirety of the projections (e.g., even the recesses) extend beyond the diameter of the spherical head to provide for good engagement with the driver for proper threading of the TAD into place into the bone tissue.

As noted previously, some embodiments include drive holes in the top of the spherical heads of the TADs to allow for threading and tightening the TAD into place. Several shapes are possible for this drive hole, including, but not limited to, square, hexagonal, or star-shaped (such as the TORX™ system that is used widely in automotive applications). The spherical heads may be cast or machined. Beneficially, casting the spherical heads may for more complex drive hole shapes than machining.

Although the example TADS illustrated in FIGS. 1A-1E include tapered collars, not all embodiments include tapered collars. Some embodiments include collars that are not tapered.

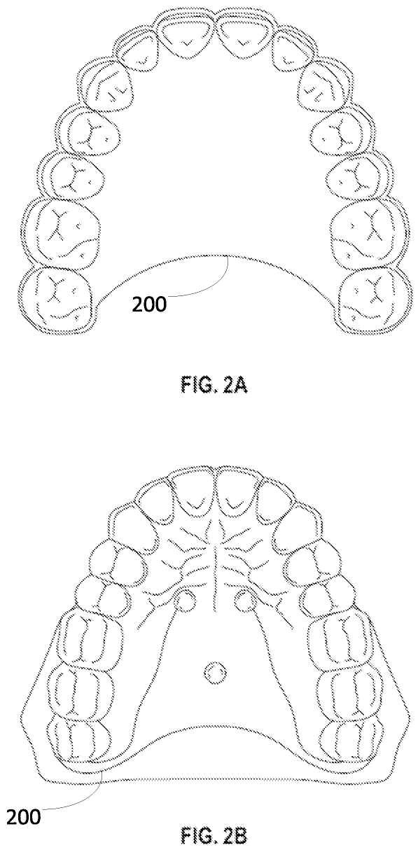

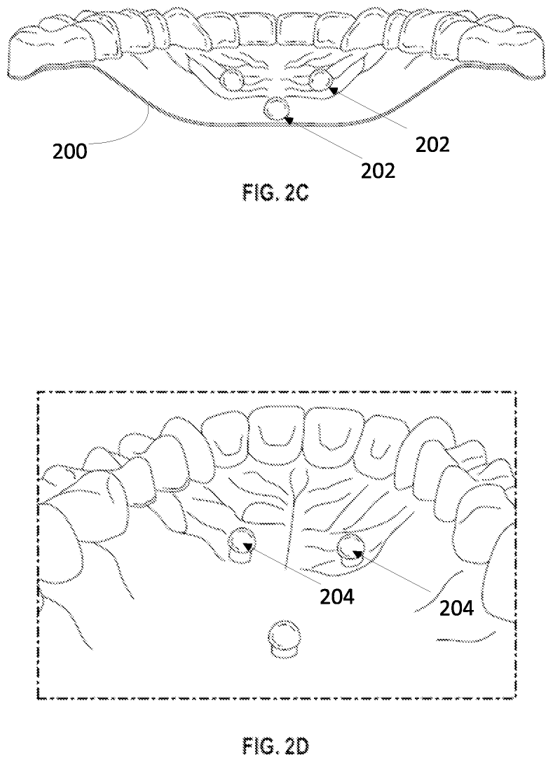

FIGS. 2A-2D are schematic diagrams of example aligners 200 and dental models for forming aligners in accordance with embodiments described herein.

Traditionally, aligners cover the teeth only, or just a small area of gum tissue near the teeth. In contrast, at least some embodiments of the aligners described herein include at least partial coverage of the palate. Beneficially, aligners that include at least partial palatal coverage may allow for engagement of TADS for nearly absolute anchorage control, placement of arms to control movement of specific teeth, or placement of interproximal cuts between certain teeth by providing additional support (e.g., because the cuts may weaken and disrupt continuity of traditional aligners).

FIG. 2A is a schematic diagram of an embodiment of an aligner 200 that includes full palatal coverage. This aligner may be formed by thermoforming over a 3D printed dental model that includes structures representing TADs. The 3D printed dental model may be printed based on a digital model designed using a CAD system. In some implementations, the aligner may be directly 3D printed based on a digital model designed using a CAD system.

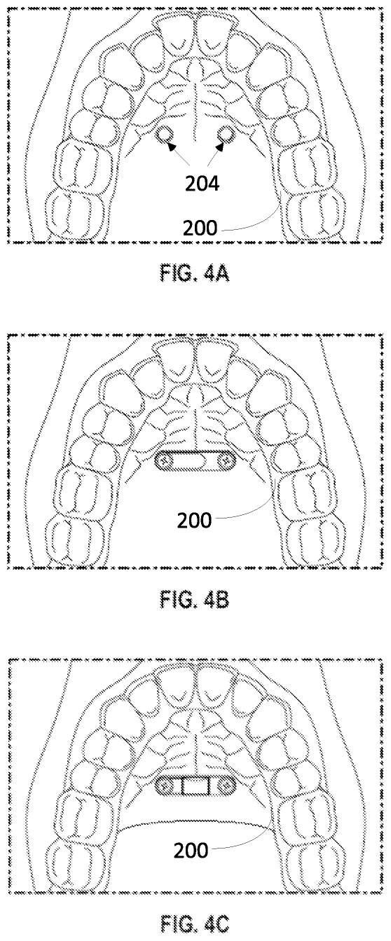

FIG. 2B shows a photograph of an embodiment of a thermoformed aligner 200 over an example 3-D printed model with full palatal coverage and three spherical-head mini-implants located in the palate. The mini-implants may secure the aligner 200 in place and provide “anchorage” when the aligner is made in such a way as to apply forces to move the teeth. The aligner includes molded recesses that are sized, shaped, and positioned to receive the heads of the TADs. Although the aligner here includes spherical recessed, other embodiments are possible with other shaped recesses. Examples of aligners with recesses having other shapes are described elsewhere herein, including with respect to FIGS. 4A-4D.

FIG. 2C shows the example aligner 200 of FIG. 2B as viewed from a posterior direction, looking anteriorly. The three recesses 202 formed over the simulated TADs on the model are visible here. The recesses may be configured to lightly engage the undercuts of the sphere, while still allowing the aligner to be easily removed without causing permanent distortion of the aligner material. The recesses may be referred to as retention sockets. These retention sockets detachably connect with the TADs.

FIG. 2D shows an example of a 3-D printed model of FIG. 2B. The 3-D model includes three simulated TADs 204. In this example, the TADs are placed in the palatal “safe zone” as described in, for example, Becker, Kathrin, et al. “Is there an ideal insertion angle and position for orthodontic mini-implants in the anterior palate? A CBCT study in humans.” American Journal of Orthodontics and Dentofacial Orthopedics 156.3 (2019): 345-354, which is incorporated herein in its entirety.

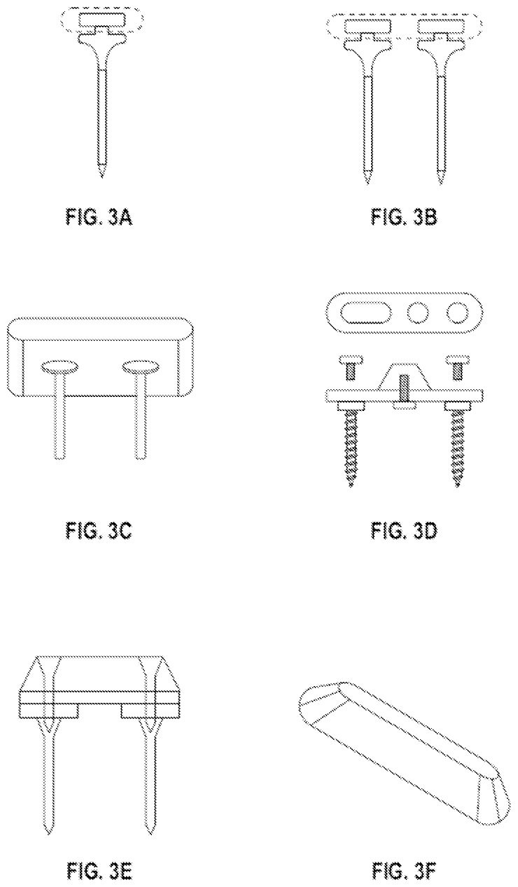

FIGS. 3A-3F are schematic diagrams of example shapes other than spheres that may be included in some embodiments to support aligner anchorage and other attachment methods, such as attaching these other shapes to plates attached to TADs inserted into the palatal bones.

FIG. 3A is a schematic diagram of an example TAD with a head, which may be similar to conventional TADs. The dotted line indicates a shape is formed to become a dental anchor unit from a dental composite or other suitable material over the head of the TAD in a paddle-shape (shown) or some other suitable shape that will allow the plastic from the palatal portion of the thermoformed aligner material (or directly 3-D printed palatal portion of the aligner, depending on the chosen method of fabrication) to fit snugly over the TAD, but will prevent dislodgement in the direction of force application (usually in an A-P (anterior-posterior) direction) that the operator intends to apply to the teeth. If the shape is formed directly in the mouth on the TAD, it will be necessary to take either a dental impression to orient the shape to the teeth or to use an intra-oral scanner to locate the shaped anchor unit relative to the teeth.

FIG. 3B is a schematic diagram of two example TADs with heads embedded in an example structure formed from dental composite or another suitable material, such as described above with respect to FIG. 3A. Beneficially, embodiments that include two TADS may provide support that is more stable and is less likely to experience a rotational movement.

FIG. 3C is a schematic diagram of two example TADs, which may be similar to the example TADs of FIG. 3B, with heads embedded in an example structure formed from dental composite or other suitable material, but with a different modified shape that has a flat occlusal surface and lateral surfaces shaped more like an elongated cylinder. Embodiments may include any suitable shape as long as there are no significant undercuts and a slight taper going occlusally away from the gingiva is included. The structure may be premade with hollow receptacles to fit over the TADs that could be filled with composite resin before curing with a light. A rubber dam with holes punched to fit over the TADs could prevent over contouring the composite into the gingiva and could allow a smooth underside surface to be obtained where access is limited. When use of the anchor unit is no longer needed, the composite can be cut away with a high-speed bur, then the TADs can be threaded out.

FIG. 3D is a schematic diagram of an embodiment of an example two-piece TAD system. The two-piece TAD systems include the option of using adjustable plates with holes through which locking screws are inserted into the portion of the TAD that goes into the bone.

In this figure, a plate is shown that may be retained in place by screws going into the hollow threaded holes in the TADs. Additionally, the plate includes a center shape disposed between the screw holes. The center shape may have various shapes and sizes. The center shape may be configured to serve as an anchor for an aligner that is shaped to fit over it. As with the other shapes shown and described earlier, the final shape is variable, but at least some embodiments have flattened faces fore and aft and will be small enough for an impression to be taken over it, or an intra-oral scan to be made over it, and small enough for the aligner material to thermoform or to be printed over it. The center shape may be small enough to prevent too much speech interference. Beneficially, this this design may be more easily removed, placed, and modified than at least some other embodiments, and can be fabricated outside the mouth and simply placed in the mouth.

FIG. 3E is a schematic diagram of an embodiment of a two-piece TAD system that may be similar to the system shown in FIG. 3D except that the center shape has been replace by a larger and wider element (which may be referred to as a retentive element because it may help retain an aligner) that extends to the ends of the plate, requiring longer screws, as the retentive screws that hold the plate in place must pass through the retentive element before entering the holes in the top of the TADs.

FIG. 3F is a perspective schematic diagram of an embodiment of the retentive element, which may be similar to the retentive element that is illustrated and described in FIG. 3E. The proportions and the amount of taper can vary in different embodiments. The screws holding the retentive element are not shown. This schematic diagram is meant to convey more information about the possibilities that exist for an anchorage element based on the idea of anchoring a fixture to two TADs with screws. In this example, the TADs shown are roughly parallel in orientation.

FIGS. 4A-4C are example TADs and aligners 200 in a patient's mouth. FIG. 4A shows a patient's mouth with two example TADs 204 implanted in the palate. The TADs are placed in an approximately parallel orientation.

FIG. 4B shows an example plate structure coupled to the example TADs of FIG. 4A. The plate structure is coupled to the TADs with attachment screws. The plate structure is a flat oval shape with a first round hole and a second elongated oval hole. In some implementations the plate is similar to the BENEplate described in Wilmes, Benedict, Dieter Drescher, and Manuel Nienkemper. “A miniplate system for improved stability of skeletal anchorage.” J Clin Orthod 43.8 (2009): 494-501, the entirety of which is incorporated by reference herein.

FIG. 4C shows an example aligner that is engaged with an example plate that is coupled to TADs in the palate of the patient's mouth. This example plate includes a retentive element disposed between the screw holes of the plate. The retentive element may be similar to the center shapes described with respect to at least FIG. 3D. The example aligner shown in FIG. 4C includes a palate coverage portion with recesses that are shaped to fit over the TADs and the plate, including the retentive element.

The retentive element is positioned on the underside (away from the tissue) of the plate, similar to the structures shown in FIGS. 3A-3F. The retentive element may be held in place in this embodiment by a screw placed first, before the plate was inserted in place in the mouth, limiting access to the retentive screw. This is not the only method by which the retentive element could be attached to the plate. Many other suitable means of attachment could be used in embodiments too, which might work out better than using a threaded attachment. Embodiments include a retentive shape that is attached to TADs to mate with an aligner fitting over the top of it. The exact details of how the retentive element (shape) are attached to the TAD can vary. As can be seen in FIG. 4C, the aligner trim line in this example extends across the palate, posterior to the TADs. The aligner material extends lingually to the new trim line, and covers the plate with the attached retentive shape, and the TADs. A trim line for a more traditional aligner is also shown (with X's drawn across the trim line) for comparison purposes. As shown in FIGS. 3A-3F, the form and the size that the retentive element actually assumes can vary considerably and may be refined further based on experimentation and use. All embodiments that include the general concept of a retentive shape held in place by a TAD or multiple TADs that an aligner fits over precisely, so as to serve as an anchorage and support point for an aligner, to allow it to be used as a solid base from which to apply forces with the aligner to move teeth are contemplated here and are within the scope of this disclosure. The molded recesses in the aligner that precisely mate with the retentive elements may provide many benefits in at least some embodiments.

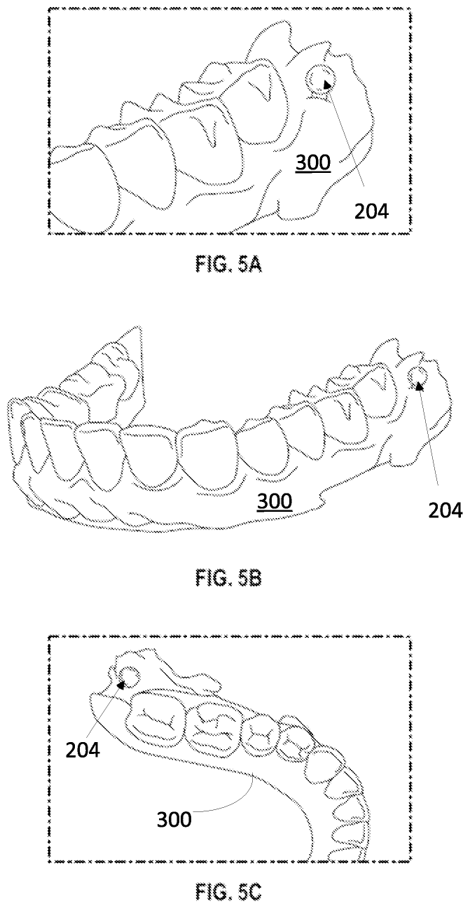

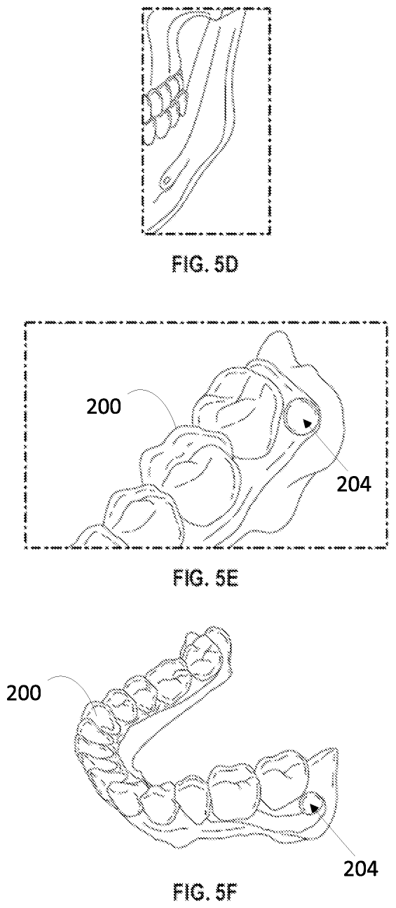

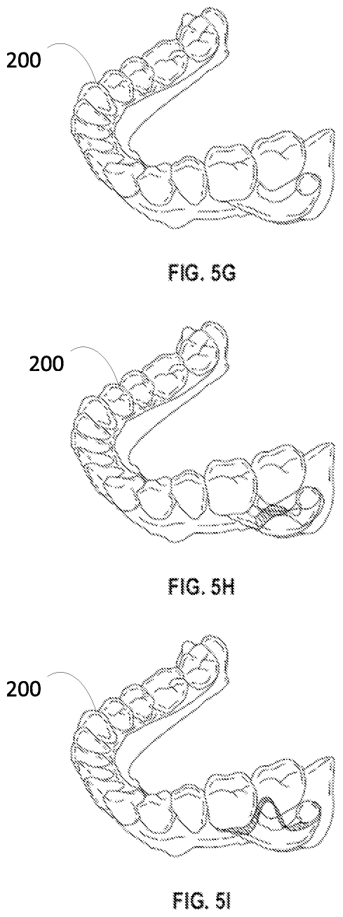

FIGS. 5A-5H are schematic diagrams of various examples of 3D printed dental models 300 with TADs or TAD analogues embedded therein and examples of aligners with recesses configured to mate with the TADs 204. For example, the aligners may provide partial coverage of gum tissue on the facial side to engage a fixed device such as a TAD.

FIG. 5A shows a model of a patient's lower jaw, specifically the buccal vestibule area distal to the second molar tooth. A simulated TAD 204 with a spherical head has been placed in this area to engage a portion of an aligner extending laterally over the gum tissue beyond the teeth.

FIG. 5B shows another view of the same model of the same patient's lower jaw and teeth, including the buccal vestibule area with the TAD 204 and the spherical head. In this view, which is more complete, and not as close-up as the previous view, the location of the TAD relative to the teeth can be more readily visualized.

FIG. 5C shows an occlusal view (looking vertically downward on the lower arch model). The placement of the spherical head TAD 204 is just distal to the second molar and is close to the buccal surface of the second molar.

FIG. 5D shows a picture of portion of the left side of the mandible and maxilla, including the posterior teeth biting together, and a portion of the anterior surface of the ascending ramus of the mandible. It can be clearly seen how close the teeth are to the ascending ramus, and how little space there is for placement of a TAD in this area, on the distal and facial side of the molars.

FIG. 5E shows a picture of an example thermoformed aligner 200 on a lower dental arch tooth model that has a simulated TAD placed on the buccal shelf toward the distal side of the second molar, but not as far back as in FIG. 5C due to the position of the ascending ramus. The aligner 200 is thermoformed over the spherical head of the TAD 204, and it is retentive, yet it is easily removable. The aligner “snaps” on and off. The TAD can enhance the anchorage potential of the molar tooth significantly, so in a situation where forces in a forward direction might be placed on the molar, the molar is much less likely to move, if that is desired to accomplish the treatment goals. For example, in cases where Class II elastics are worn, there would be more distal movement of the upper teeth with the enhanced lower anchorage provided by the TAD.

FIG. 5F shows a picture of an example thermoformed aligner 200 on a lower dental arch tooth model that has a simulated TAD placed as in FIG. 5E. The thermoformed aligner 200 is connected to the simulated TAD 204 by an arm that is continuous with and is a part of the same aligner material. The arm ends in a thermoformed “cap” that is formed over the simulated spherical TAD head. The “cap” snaps into place over the TAD. The arm as shown is roughly flat as it is formed along of the buccal vestibule as it is scanned or formed from a model made from dental impression material. Beneficially, an arm as shown in this figure, may apply a force from the TAD to move the teeth in a distal (posterior) direction, or in other words, a “pulling force.”

FIG. 5G shows a picture of another example aligner 200 on the same lower dental arch model with the simulated TAD on the buccal shelf similar to FIGS. 5E and 5F. In this case, the arm is curved to provide a little additional springback characteristic when stretched, although the basic thermoformed aligner materials are not very “stretchy.” The curved arm may for allow for additional elongation. In this example, the curved arm is shaped to remain close to the buccal surface of the tooth to avoid interfering with the inner surface of the cheeks and causing irritation of the tissue.

FIG. 5H shows an example aligner 200, similar to the aligner shown in FIG. 5G. The aligner is in place on a lower dental model with a buccal shelf simulated TAD. In this FIG. lines are drawn to show a thermoformed arm being formed into an arch shape, which it is possible to make by using computer software to generate a supporting arch forming guide on the model over the which the plastic thermoforming sheet will be formed. The vertically curved arch shape will have better spring back properties when temporarily compressed than the flatter arm.

FIG. 5I shows another example aligner 200 that is similar to the aligners shown in FIGS. 5D and 5E. The aligner shown in FIG. 5I includes lines drawn to indicate an even taller vertical loop connecting the aligner to the TAD on the buccal shelf.

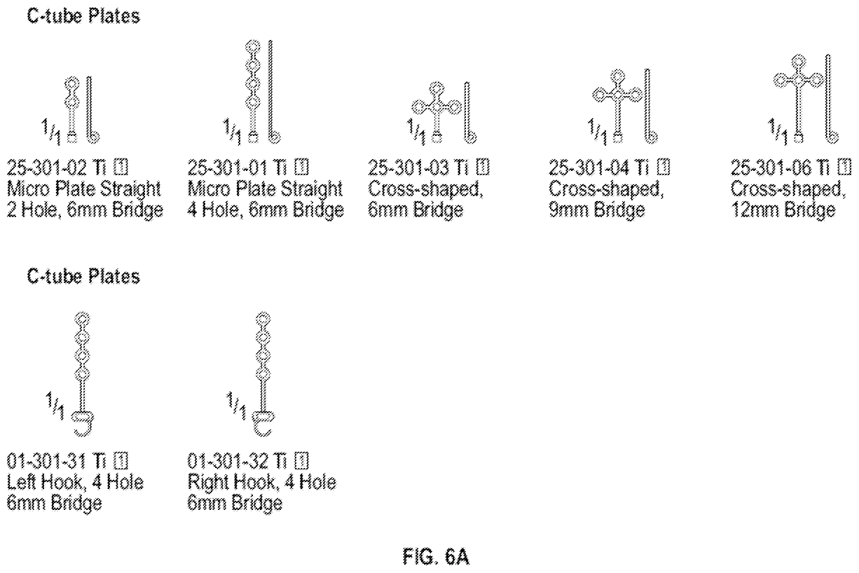

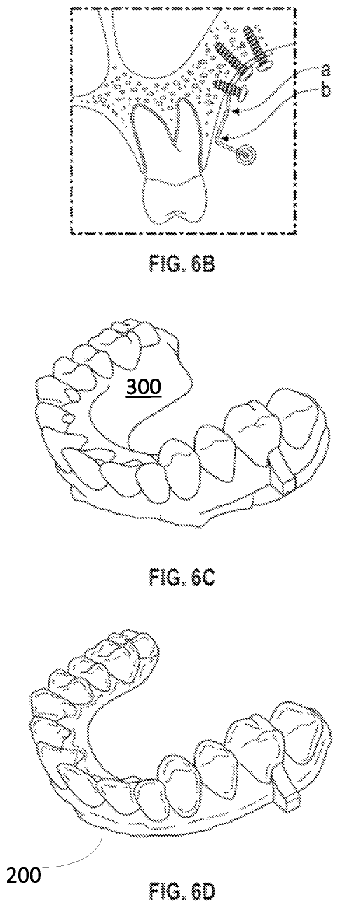

FIGS. 6A-6D show schematic diagrams of bone plate attachment tubes and aligners that are shaped to engage with those bone plate attachment tubes.

FIG. 6A shows example bone plate attachment tubes that may be used in accordance with embodiments described herein. Multiple manufacturers make screw-retained bone anchor mini-plate systems for the purpose of using boney skeletal anchorage to move teeth. FIG. 6A is picture is a page from an online downloadable PDF catalogue from KLS Martin, The OrthoAnchor System, Page 10, V7, Oct. 2, 2009, PO Box 16369, Jacksonville, FL 32245, showing straight and T-shaped bone anchorage plates. Other manufacturers have variations on this basic design. The plates are retained in place by short screws that are threaded into the bone. Most of the plate is hidden below the soft oral mucosa. A portion of the device emerges through the gingival tissue and has some sort of attachment mechanism for the orthodontic appliances including hooks, tubes, brackets, or cylinders with holes perforated through them. Embodiments of the aligners described herein may engage with any of the bone plate attachment tubes.

FIG. 6B shows an example mini-plate in a cross-sectional diagram of the maxillary bone that may be used in accordance with embodiments described herein. This particular design uses a tube which protrudes through the gingiva. The picture is from Marie A Cornelis, et al, J Oral Maxillofacial Surg 2008 July; 66(7) 1439-1445, “Modified Miniplates for Temporary Skeletal Anchorage in Orthodontics: Placement and Removal Surgeries,” the entirety of which is incorporated herein by reference.

FIG. 6C is a picture of an example model 300 of maxillary teeth turned upside down on a tabletop. The patient has had a skeletal anchorage miniplate placed on each side (only one side shows here) with a tube showing through the gingival tissue above the first molar tooth. Computer systems and software as described herein may implement methods to prepare or allow a user to prepare a tapered rectangular guide that goes over the mini-plate tube. The guide will allow a thermoformed aligner to be fabricated over the teeth and over the guide so the aligner will contact mesial and distal surfaces of the tube and tightly engage the skeletal anchor but will not get “caught” in an undercut under the tube, so the patient will be able to place and remove the aligner easily over the teeth as well as the skeletal anchor. The presence of this skeletal anchor will allow the designers of the aligner treatment plan to move the molar teeth mesially or distally, relative to the skeletal anchor point, in very small increments.

FIG. 6D shows an example of a clear aligner 200 that has been thermoformed over the maxillary tooth model shown in FIG. 6C, with the skeletal anchor guide in place, as formed over the tapered rectangular forming guide by the software. In some implementations, a clear aligner is designed to fit and engage with the rectangular forming guide using the software.

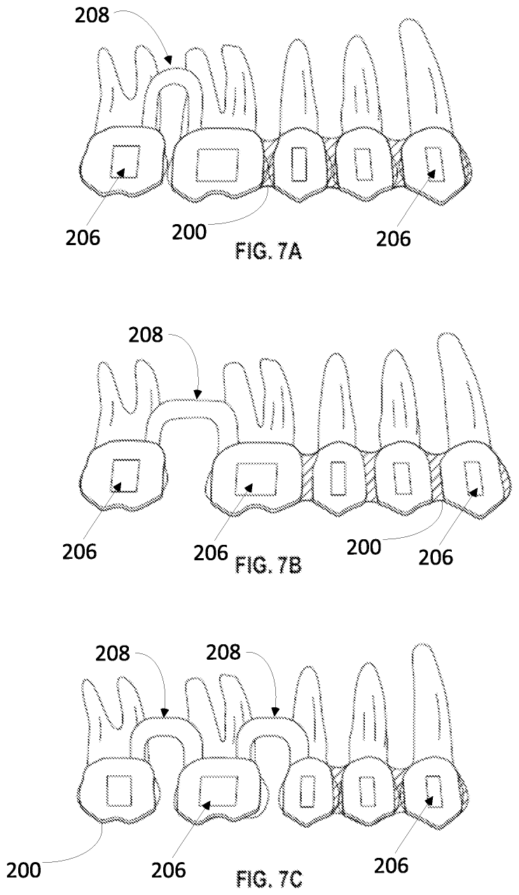

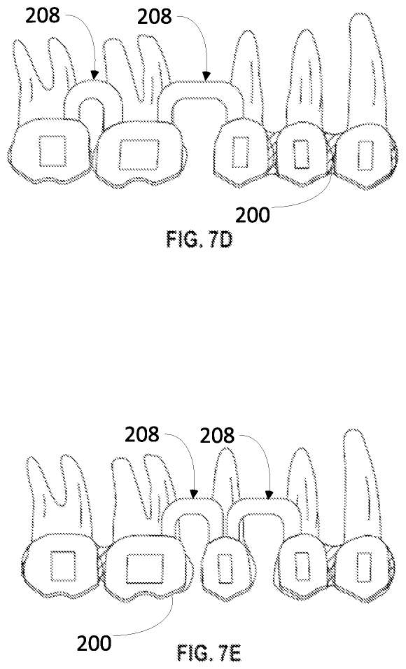

FIGS. 7A-7E are schematic diagrams showing a series of aligners that are performing sequential (serial) distal movement or mesial movement of upper or lower teeth. The concept of sequential distal movement or sequential mesial movement has been used with fixed orthodontics. The aligners shown herein use loops to perform sequential distal movement or mesial movement with clear plastic aligner.

FIG. 7A shows a drawing of an example aligner 200 in place over maxillary teeth. No gums or bone support is shown. The aligner is sectioned so the upper second molar is free to move relative to the other teeth with the constraint that it is attached to the remainder of the aligner by a loop of the same material that the aligner is made from. The aligner is formed of a single piece of material, but the upper second molar is a little more free to move than the other teeth due to the fact that it is sectioned away from the other teeth by a thin interproximal cut, but is not completely free because it is still attached on each side by the large plastic loop extending over the gum tissue on the facial side. The lingual side is not shown in the view.

FIG. 7B shows a drawing of an example aligner 200 in place over maxillary teeth, similar to the one shown in FIG. 7A. The first step of serial distalization is shown here with the upper second molar moved distally. The arch connecting the sectioned second molar has been made longer compared to the arch of the aligner shown in FIG. 7A, and the arch provides the force to move the second molar distally, although force is also supplied on the lingual side by other means. Note there are rectangular attachments placed on all the teeth to prevent tipping of the teeth while the distal movement is taking place. Other attachment shapes could be utilized rather than rectangular. At least one important feature of attachments includes having at least one side that engages a recess within the aligner. This side can be flat or beveled or curved but it must resist root movement. In at least some embodiments, the surface parallels the long axis of the root. Although the attachments may provide many benefits, not all embodiments include attachments.

FIG. 7C shows a drawing of an example aligner 200 in place over maxillary teeth, similar to the aligners shown in FIGS. 7A and 7B. This is the next step in the serial distalization—the first molar is being moved back. It is not all the way back—it is in the process of being moved. There is a space both mesial and distal to the first molar. The second molar is serving as an anchor tooth as are all the other teeth in the upper arch except the first molars.

FIG. 7D shows a drawing of an example aligner in place over maxillary teeth, similar to the aligners shown in FIGS. 7A-7C. In this view, the first molar has been moved all the way back in a distal direction until it has achieved contact with the second molar which was previously moved back. The space present between the first molar and the second premolar, visible in FIG. 7C has now increased. Ideally, if the fixed bonded attachments 206 are engaging the aligners properly, the roots are parallel, and the teeth are not tipping. If some tipping does occur due to flexibility of the loops 208 or play between the aligners and attachments, some overcorrection of the distal root movement can be built into the aligner program software.

FIG. 7E shows a drawing of an example aligner in place over maxillary teeth, continuing the serial distalization process shown in FIGS. 7A-7D. This drawing shows the second premolar moving distally back into the space which exists anterior to the first molar teeth, but the second premolar is only partially moved back through the space. It is important to note that there are two loops 208, mesial and distal to the second premolars. The loop 208 that was formerly in place in FIG. 7D between the first and second molars has been removed, and the aligner has now been joined together between these teeth, to improve anchorage. All teeth except the second premolars in the upper arch, which are currently being moved are being used as anchor teeth at this point. Optionally, if there is crowding in the incisors (not shown in these views), the aligners could be actively used to align the incisors at the same time the second premolars are being moved distally.

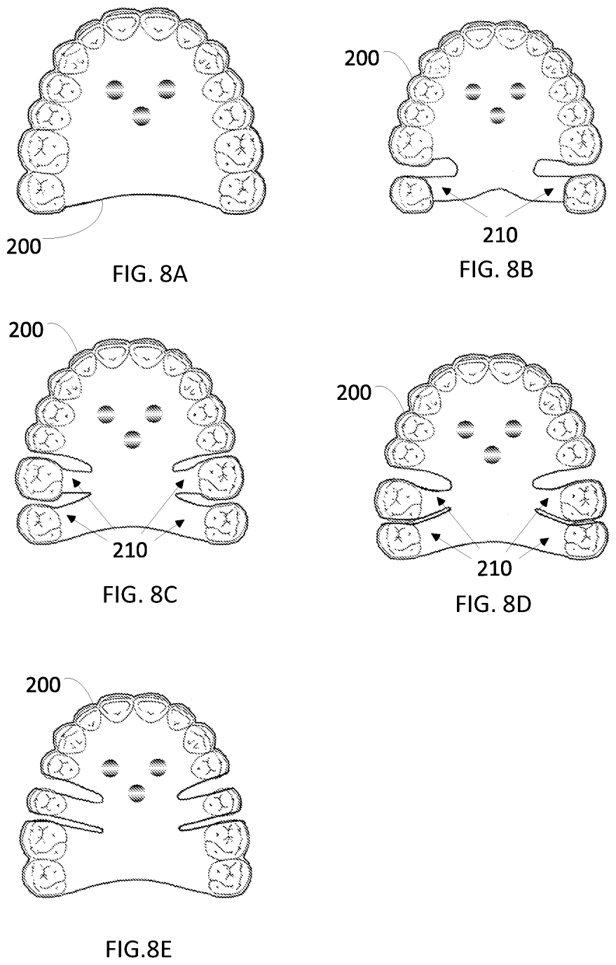

FIGS. 8A-8E are schematic diagrams showing a series of aligners that are performing sequential (serial) distal movement or mesial movement of upper teeth. These aligners include palatal coverage that engages TADs placed in the upper palate. The aligners may also include arms extending from the palatal coverage region. The arms may be joined to separate aligner sections of the upper arch. The arms may apply force to the teeth individually.

FIG. 8A shows a drawing of upper teeth from the occlusal view (from below, looking upward toward the palate and the biting surfaces of the teeth). There is an outline of an example aligner 200 surrounding the teeth, and there are three circular simulated implants, located in the “T-shaped” safe zone for palatal implant placement as discussed previously with respect to FIG. 2D. This stage of movement corresponds to FIG. 7A in the lateral view, before distalization begins.

FIG. 8B shows a similar drawing of upper teeth, like in FIG. 8A. In this drawing, the second molar teeth have been moved distally by a series of small incremental steps, using a series of aligners 200 to arrive at the stage shown here. The molar teeth are sectioned away from the other teeth but are connected to the rest of the aligner 200 by palatal arms 210, made of the same material that forms the body of the aligner. This stage corresponds to FIG. 7B in the lateral view, when the second molar tooth has been moved distally. Although no arch connections (loops) like those shown in FIGS. 7A-7D are shown in this figure, some implementations do include such loops, which may act in concert with the palatal arms 210 to induce movement of the teeth. Additionally, double metal arches, like those shown in FIGS. 11A-11C may be included in at least some embodiments. Other suitable connection materials or structures may be used as well.

FIG. 8C shows a schematic drawing of upper teeth, similar to that shown in FIGS. 8A and 8B. In this drawing, the first molar teeth have been moved distally by a series of small incremental steps, using a series of aligners, to arrive at the stage shown here. This position corresponds to the stage shown in the lateral view in FIG. 7C. The first molars have been moved approximately halfway horizontally back as far as they need to go to contact the second molars. The arms on the second molars are used to anchor those teeth in place. The arms on the first molars change with each successive stage to keep the first molars moving distally.

FIG. 8D is a schematic drawing of upper teeth with an aligner outline, very much like FIG. 8C. One difference is that the first molar teeth have been moved distally all the way back until they have contacted the mesial surfaces of the second molars. This stage is a little farther along in the serial distalization process than FIG. 8C and corresponds to the lateral view shown in FIG. 7D.

FIG. 8E shows a similar drawing of upper teeth with an aligner outline, as a continuation of the series shown in FIGS. 8A-8D. In this view, the upper second molars followed by the upper first molars have been moved distally. The four molars are now together and can be used as anchors, along with the TADS, to help move the remaining teeth. In this figure, the second premolar is shown moving distally just a little more than half-way across the space created by moving the molars distally out of the way. The teeth can be moved this way, one at a time, but the process is time-consuming. In some implementations, multiple teeth are moved at the same time. Beneficially, the use of TADs provides better and more secure anchorage, thus allowing movement of more teeth. With some implementations, it may be possible to safely and more quickly move more than two teeth at a time. In addition to moving one tooth per side at time, some implementations move two teeth per side at a time, three teeth per side at a time, or four teeth per side at a time.

Some embodiments include modified (with respect to traditional aligners) outlines for the aligners, to provide active elements for tooth movements. At least some of the modifications have already been described and include arches on the facial side which extend over the gum tissue. When the aligners are fitted over fixed tubes or other attachments connected to TADs on the facial side, special shaped forms are computer generated that extend beyond the regular dental borders of the aligner to engage the attachments. When lower TADs on the facial side of the molars are used, arms which enlarge the borders of the aligner of various configurations including straight, and laterally and compound and complex curved surfaces as well as vertically curved arms are used to engage the TADs. On the palatal side, modifications to the outline of the aligner can include arches, partial palatal coverage, complete palatal coverage, partial palatal coverage with arms extending to selected teeth. The arms can be straight or curved. The palatal coverage can end with a straight posterior border or with a curved posterior border.

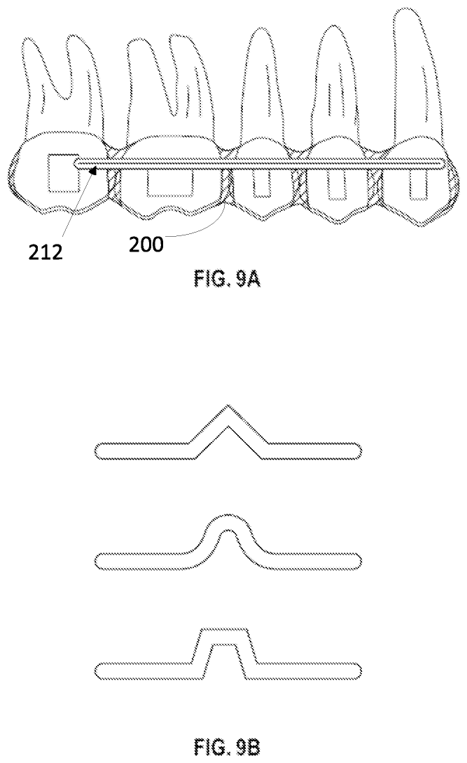

FIGS. 9A-9B are schematic diagrams of embodiments of aligners 200 with reinforcing structures. These reinforcing structures 212 may reduce the likelihood of flexing under load in certain dimensions.

FIG. 9A is a schematic drawing of a lateral view of an upper aligner. The portion of the aligner covering the incisors is not shown. A raised thermoformed three-dimensional feature (reinforcing structure 212) on the surface of the aligner extends horizontally along the lateral surface of the aligner from the second molar anteriorly to the cuspid tooth and across all the teeth in between. The raised feature (reinforcing structure) acts as a ridge to limit the bending of the material. The raised feature is designed at the time the treatment is planned, and the ability to incorporate this feature into each of the incremental printed models required to manufacture the aligners is part of the software. There are options for the cross-section of the ridge design and for the size, length, and positioning of the ridge feature.

FIG. 9B is a schematic drawing of different cross-sections of embodiments of the raised feature (reinforcing structure 212). These are not the only possible choices, but also illustrate the concept of elevated (or depressed) ridges for stiffening. The reinforcing structure enhances the stiffness in the longitudinal direction, with a horizontally running ridge, which will help increase the overall stiffness of the body of the aligner, allowing the aligner to deliver higher intrusive forces on the incisors. These reinforcing structures may be more beneficial in levelling the lower dental arch than the upper arch because the Curve of Spee is usually greater in the lower arch than in the upper arch.

The upper drawing shows a cross-section with relatively straight “sides” coming out at approximately 45 degrees from the surfaces of the teeth, meeting together at approximately 90 degrees, in a single ridge. These angles can vary. The surfaces coming away from the teeth could be in the range from approximately 20 degrees to 70 degrees. In the more extreme ends of these ranges the central ridge angle could vary from 140 degrees to 40 degrees. At the 40 degree end of the spectrum, the ridge would be sharp.

The middle drawing shows a rounded cross section ridge. The relative dimensions can vary. Beneficially, this cross-section of the reinforcing structure may be smoother on the inside of the patient's cheek or on the patient's tongue.

The bottom drawing shows a ridge cross section with a flat outer edge. Again, the relative dimensions can vary. Embodiments are possible with many different ridge shapes to control the stiffness of an aligner in a specific dimension.

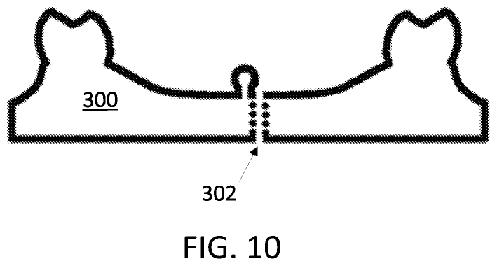

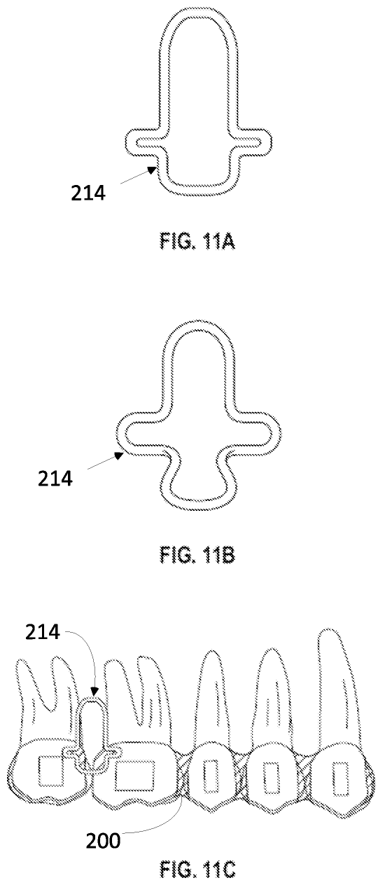

FIG. 10 is a schematic diagram of a cross-sectional view of an embodiment of a dental model 300 with a hole 302 to allow more complete thermoforming to an analogue TAD structure. Various embodiments may include one or more such holes around the bases of any included analogue TAD structures. The holes may allow air to escape so that bubbles do not form and impede the thermoforming of the plastic material into the region surrounding the analogue TAD structures. The holes may be designed in a digital model by the computing systems described herein and the digital model may be used by 3D printer to fabricate the physical dental model.

As described above, air passages may be made through the dental model to improve the abilities of vacuum and air-pressure thermoforming machines to form around undercuts.

The cross-section shown in FIG. 10 includes a dental model with a palatal object containing an undercut. The model has a flat base. The upper surface of the model is called the anatomic portion. The cut is made transversely through the model, so a cross section of a posterior tooth on each of the right and left sides are shown. Dotted lines indicate the location of the tubular opening through the model base with the superior opening close to the undercut object (in this case a simulated TAD with a spherical head near the palatal midline). When thermoforming machines are used, a thin sheet of heated plastic material is placed over the top of the model. Either a vacuum is applied to the underside of the heated plastic sheet or pressurized air is applied to the upper side of the heated plastic sheet. Either way, it is easy for a small volume of air to get “trapped” in the lowest portion of the palate under the plastic sheet and to form a “bubble” in the formed dental model contour. Since the simulated TAD is near the lowest portion of the palate (in the inverted model), if there is any trapped air, the detail of the undercuts may not be accurately reproduced in the plastic sheet. The air passage allows the “trapped” air to escape easily, allowing the plastic sheet to adapt more fully to all contours of the model, especially the detail of the undercut around the TAD.

FIGS. 11A-C show embodiments of preformed double loops and embodiments of aligners that incorporate the double metal loops. The preformed double loops may be formed from a metallic heat-treated material. The pre-formed loops may be attached to an aligner to achieve space opening and space closure.

FIG. 11A is schematic drawing of an embodiment of a metallic double loop wire 214. The dimensions and proportions of the loop can vary from this drawing. In some embodiments, the wire is formed from heat-treated Ni—Ti memory wire, so when the wire is deformed it will return to the shape it was when heat-treated. The loop may be designed to go between teeth, between sections of the aligner primarily where it is desirable to open or to close spaces. Additionally, these loops can also be applied to accomplish other types of tooth movement, such as the correction of rotations, alignment of crowns, uprighting roots of teeth, or accomplishing torquing movements. The diameter of the wire can vary, but the diameter of at least some embodiments would be on the order of 0.030 to 0.035 inches, to allow the overall appliance to have some rigidity and integrity. Some embodiments have wires with a diameter as small as 0.019 inches. As the drawing shows, there are two main loops. The superior loop is the larger of the two and extends almost vertically over the supporting bone and gum tissue over the roots of the teeth and over the interproximal space. There are two smaller side loops that serve the purpose of attaching the overall loop device to the appliance with bonded composite material or other suitable adhesive such as Bond Aligner™, manufactured by Reliance Orthodontic Products, Inc. 1540 West Thorndale Ave., Itasca, Illinois 60143. There is also an inferior loop that is not in the same plane as the superior loop and the two side loops. It is expected that this loop plane will be approximately 70 degrees to the plane of the other loops. In other embodiments, the degrees to the plane may range anywhere from between 85 to about 160 degrees. Other angle configurations may be used depending on a size of the loop relative to for use for a size of the patient's teeth. The inferior loop may be smaller than the superior loop and extends in an occlusal direction over the side of the appliance, whether used on the buccal or lingual side. In some implementations, the loops are pre-made in a few sizes depending on how large the space and the teeth are, and how much movement is desired for a particular stage. The loops will be primarily used on the facial side of the teeth, but can also be used on the lingual side. These loops can be mixed or used in combination with other types of active elements such as active lingual arms, plastic loops on the facial or lingual side, etc. The primary advantage of the double loop design is that the two loops counter-act the tendencies of loops to induce tipping forces as teeth are moved, whether spaces are being opened or closed, if the loops are parallel to the plane of the movement of the teeth. The teeth will tend to translate in a parallel manner if appropriate attachments are applied to the teeth and they are engaged properly by the aligners.

FIG. 11B shows a photograph of a double wire loop 214, with the superior loop and the much smaller two side loops in one plane. The photograph illustrates the problem of fabricating a closed loop from wire, as there is a beginning and an end to the wire. It is advantageous to bend the wire in such a way as to have the ends of the wire occur in the small supporting loops where they will not adversely affect the bending properties of the main loops. The ends of the wire can be joined together by soldering or welding, or they can be left unattached as they are shown here. The wire loop can be attached to the main body section of the aligner, and on the other end of the loop to individual tooth-clasping segments (or elements) that have been cut away from the rest of the aligner, as previously described, by using a bonded composite resin material or by using a material such as Bond Aligner™ made by Reliance Orthodontic Products.

The inferior loop, which is not in the plane of the other three loops, is shown at angle of approximately 80 degrees to the plane of the other loops. As stated earlier, the one purpose of this second main loop is to counteract the tipping tendency of the teeth which will occur as the main loop is stretched open. The ability of the loop to effectively counteract the tipping force will be reduced as the angle of the inferior loop is increased relative to the plane of the primary loop. If the inferior loop is at an angle of 10 or 15 degrees to the superior loop, it will nearly balance out the tipping force, but may have to be made shorter to avoid occlusal interference. There will be a balance to try to achieve through experimentation and testing to arrive at the optimal point of angle change vs dimensional change in the inferior loop. Also, the wire diameter and heat treatment parameters can be changed to achieve optimal force delivery.

FIG. 11C is a schematic drawing of a right-side view of the buccal surface of an upper aligner 200 with the second molar tooth sectioned away from the rest of the body of the aligner. The double wire loop 214 spring connector is shown in place connecting the second molar segment to the remaining body of the aligner. This is to illustrate a possible configuration where the double loop spring could be activated to move the second molar tooth distally, as part of a serial distalization procedure, or it could be activated as a space closing spring to bring the second molar tooth anteriorly, if that was the desired movement. Example serial distalization procedures were described and illustration with respect to FIGS. 7A-7E and 8A-8E. It should be understood that a metal spring, or series of metal springs in incremental appliances, could be activated to apply force to accomplish the type of movements illustrated earlier.

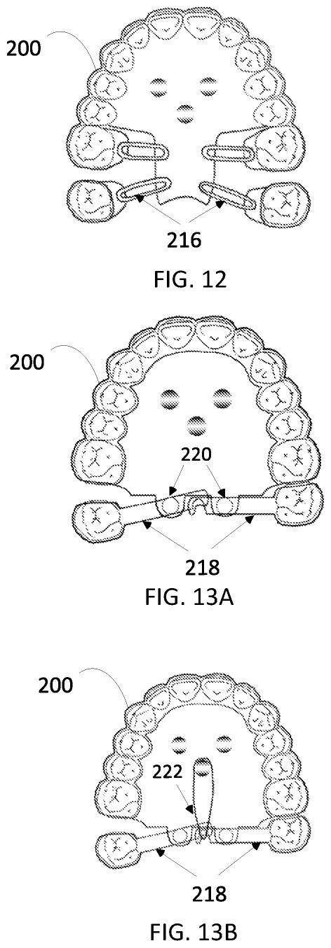

FIG. 12 is a schematic diagram of curved closed metallic loops 216 on the palatal side of upper aligner appliances that can serve as active elements to achieve efficient mesial or distal movement of individual teeth.

FIG. 12 shows a palatal view (upper occlusal view) of an upper dental arch with an aligner in place. There are three palatal implants with spherical heads placed in the “safe” T-Zone as described by Benedict Wilmes for anchorage. There are four closed (soldered or welded) metallic curved loops, 2-sets of 2 loops each, extending to the second molars and to the first molars. As long as there is adequate TAD anchorage to support it, some embodiments may be used to move all four molar teeth at once, rather than performing the usual sequential distal movement of two teeth at a time. It is intended that these loops will preferably be made of heat-treated Ni—Ti wire to take advantage of the shape memory properties of that material, however, the loops could be made of any suitable wire material. It is also intended that a series of aligners will be made to move the teeth in a series of incremental small steps. With each activation, the wires will tend to move teeth in a small arc, with the tooth tending to move lingually as it travels toward the distal end of each activation. In some implementations, the next step will include a compensatory lateral offset of the tooth to overcome this tendency for the teeth to move lingually. These offsets may be small and should not interfere significantly with the intended path of movement. Fabrication of the aligner appliances could be done using one layer of thermoformed clear material, with the wires held in place using a light-cured adhesive such as Bond Aligner, made by Reliance Orthodontic Products, described earlier. The clear aligner material could also be formed from two layers, with the wires in place between the layers. Again, each step in the sequential distalization sequence is not shown, but is clearly understood to be a part of the treatment process, unless it is elected to move teeth more rapidly, and to move teeth four or more at a time, instead of the usual two at a time as with conventional sequential distalization.

FIGS. 13A-13B illustrate embodiments of aligners with hinged arm elements with active elements for distal movement of posterior teeth (molars).

FIG. 13A shows an upper occlusal view of teeth with an example aligner 200 in place. Again, the three palatal TADs placed in the “T” shaped safe zone are present and the aligner is thermoformed to precisely fit over them. In this embodiments, a 3-D printed plastic layer covers the palate and extends distally to approximately a line between the most distal teeth to be moved (in this case the second molars) to serve as a mechanical support for 3-D printed pivoting arms 218 that extend to the second molars (or whichever teeth are being presently moved). The pivot point 220 can be 3-D printed with a 3-D printed pivot axle shaft, or metal or plastic hardware can be provided for this purpose. As shown in the drawing, there are elastic hooks built into the pivoting arms to which removable elastic elements such as rubber bands or stretchy elastomeric modules can be attached. As shown, the second molar will tend to rotate distally and to move lingually as it rotates around the vertical axis of rotation, which may not be desirable. Some embodiments compensate for this by designing each aligner stage to move the second molar in a buccal direction a small distance.

FIG. 13B shows the same drawing as in FIG. 13A, but with the addition of a rubber or elastic band 222 connecting a hook in the location of one of the TADs in the support plate to the hooks on the central portion of each of the two lever arms connected to the second molars on the opposite side of the vertical axis of rotation from the tooth. The force applied by the elastic member is applied to the teeth as a force mainly in the distal direction (although with a small rotational component). The advantage of having the force applied by the elastic member is that not as many aligner stages are required, and a more continuous force can be applied to the molars as long as the patient keeps the elastic in place.

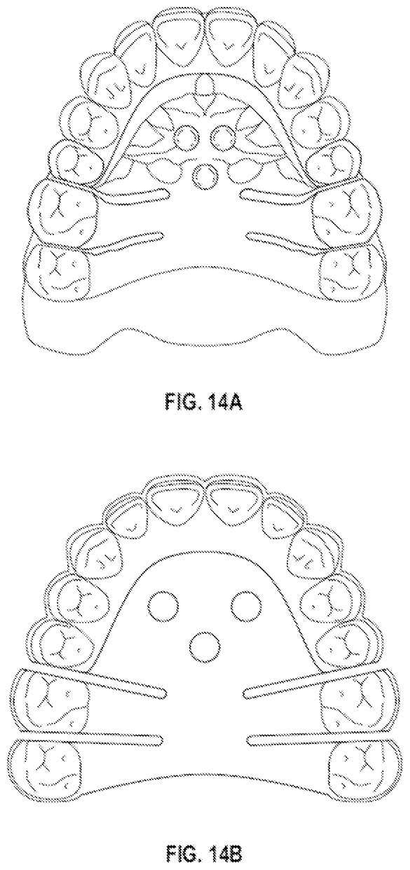

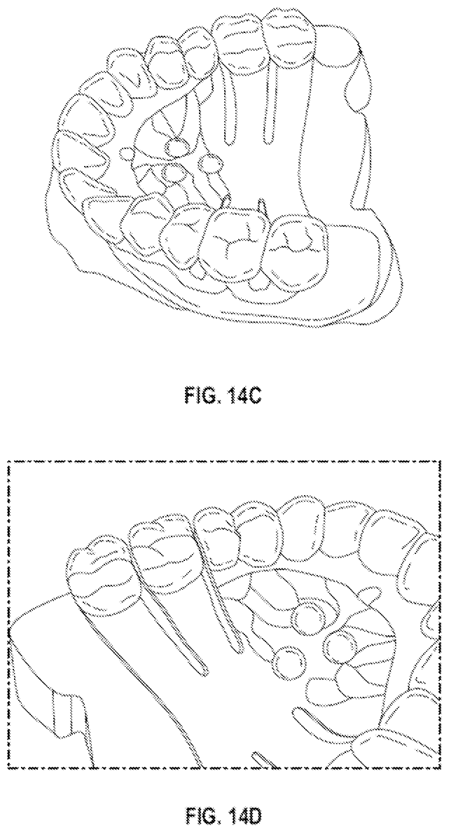

FIGS. 14A-14D illustrate embodiments of aligners that couple to TADs. These aligners may include multiple flexible arms to apply forces on teeth to achieve sequential distal or mesial tooth movements.

FIG. 14A shows a photograph of an embodiment of an aligner 200 fitted on a 3D printed model 300 with the same type of spherical TADs in the “safe” zone of the palate as described above. This aligner may be formed from two layers of thermoformed material. In this example, the first thicker layer is 0.040 Zendura, although other thicknesses and other materials could be used. The layer may then be trimmed. The outline can be seen a few millimeters away from the lingual side of the teeth although this is not the only way this thicker material could be trimmed. The material can also be seen extending up on the lingual side of the first and second molar teeth where it provides support for these teeth. A second layer is then thermoformed over the first thermoformed layer and over the teeth. This layer forms the main body of the aligner appliance and engages the teeth. The two layers of thermoformed material mostly fuse together when heated. In this example, the aligner material has been trimmed so the first and second molars have lingual arms extending to them. On the facial side in this example, the aligner has been trimmed so the first and second molars are connected to each other and to the second premolar by buccal side plastic thermoformed arches made out of the same single piece of plastic that became the second layer of the appliance and that extends over the teeth. The molars have lingual two-layer arms connecting to the central palatal portion of the appliance, and on the buccal side these same molars are attached to each other by plastic arch loops. The arms may distribute a force on the molars to move the molars.

The buccal side method for attaching the tooth clasping elements to each other and to the central core of the appliance, and also the type of lingual (palatal) force generating arm or tooth attachment method can vary with the desires of the clinician for each particular case and situation that is faced. The devices can be mixed and varied. There are many possible combinations. It is not necessary to use the same combinations of connecting arms consistently in the same appliance. Many combinations are possible even on the same appliance.

FIG. 14B shows a drawing of the same type of appliance as was shown in FIG. 14A. The two layers of material are outlined in black showing how the first layer covers the palate, including the spherical TADs, but does not quite extend to the anterior tooth gingival margins. The layer does, however, partially cover the lingual surfaces of the first and second molars. The arch-shaped loop connectors between the molars and the second premolars are not shown because they are in undercut areas that would not be visible from this direction. This shows only a stage for moving molars. It is to be understood, based on previous descriptions given above, that this same type of appliance could also be used to move premolars, cuspid teeth, and incisors, in a properly sequenced series.

FIG. 14C shows a photograph of the same aligner and model shown in FIG. 14A, this time from a side perspective showing the arch-shaped loop connectors on the right buccal side (the model is inverted).

FIG. 14D shows a photograph of the same aligner and model shown in FIGS. 14A and 14C, showing more clearly the two layers on the lingual side of the first and second molars. The two layers of material (in this case 0.040 and 0.030) added together allow the arm to flex but add considerably to the torsional stiffness of the arm, resisting the tendency for the molar tooth to tip as it is being moved distally. The thickness and the materials used can vary and still be within the scope of this invention.

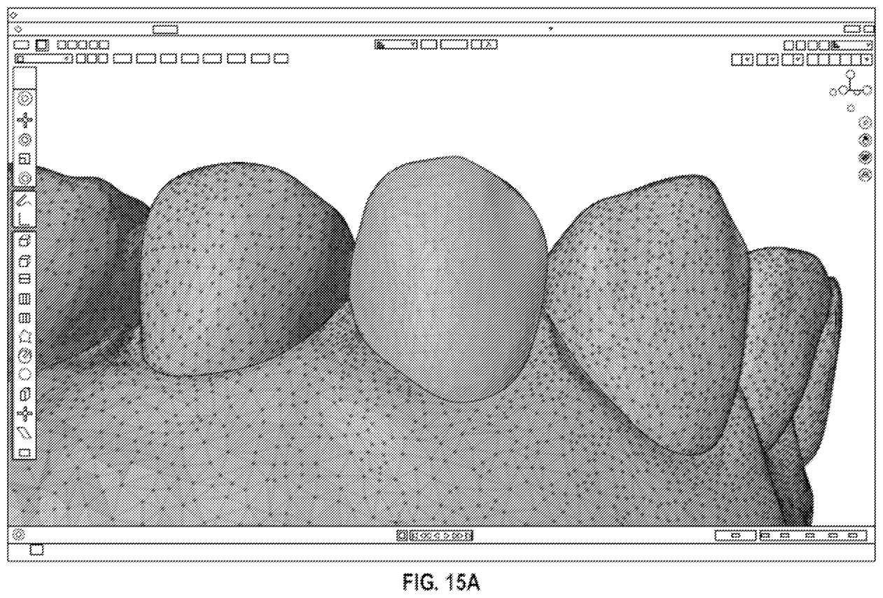

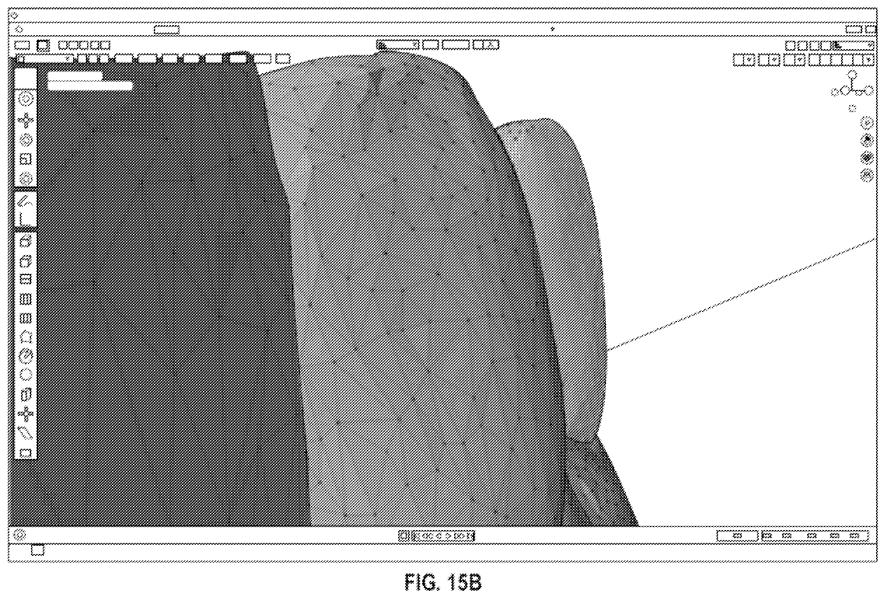

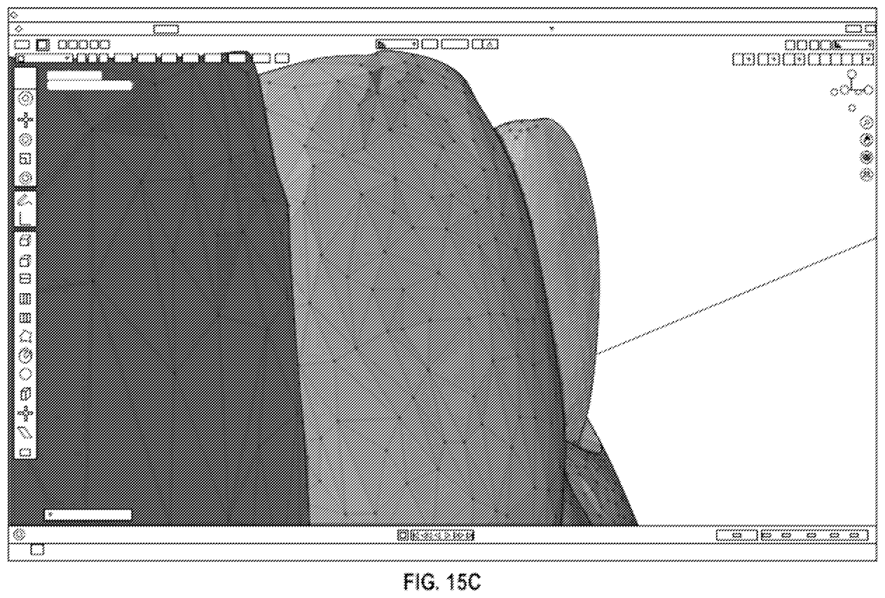

FIGS. 15A-15C are schematic diagrams illustrating a CAD-based process to adjust the contours of digital teeth in appliance-forming models to increase appliance retention.

FIG. 15A shows a digital triangle representation of a 3D model of an actual patient's upper teeth. The model is inverted so the teeth are upside down. The incisor teeth can be seen on the right side of the picture, with the cuspid tooth on the right side also, but to the left of the incisors. The highlighted tooth in the center of the picture (with the triangle vertices a lighter shade, not black) is the first premolar. The contour of this tooth is modified from FIG. 15B to FIG. 15C.

FIG. 15B shows another view of the same tooth that was highlighted in FIG. 15A. The perspective in the viewing software has been changed to simulate the viewer's eye being close to the teeth, and with the viewer's eye aimed in an anterior direction, looking forward toward the front of the mouth. The closest tooth to the viewer is the second premolar. The second tooth in this view is the highlighted tooth (with the light-shaded triangle vertices). The contour of this tooth is modified in FIG. 15C.

FIG. 15C shows a similar view to the view in FIG. 15B. Going back to FIG. 15A, the entire buccal surface of the tooth which was highlighted has now been moved. Think of the cusp tip as a pivot point. In this example, the buccal surface of the tooth has been rotated inward, toward the midline of the mouth, about the cusp tip. Because the movement is a rotation about the cusp tip, the portions of the surface nearer to the cusp tip will move less than those further away, near the gingival margin. In some implementations, the region near the gingival margin moves by approximately 0.5 mm to 1.5 mm. The area just above the gumline shows a small ledge, indicating where the old surface used to be prior to it having been moved inward.

Some embodiments include aligners with various layers of liner material to provide increase strength in various regions. These layers can be 3-D printed or can be thermoformed out of the same material the aligner is made from or from different thermoformed materials, or made from completely different materials, such as metals or meshes. The flex or modulus properties of each layer can be different, affecting the overall properties of the aligner. Related concepts were disclosed by Martz in U.S. Pat. No. 4,793,803, filed in Oct. 8, 1987, the entirety of which is hereby incorporated by reference.

In some embodiments, a palatal layer is used as a reinforced central platform to engage TADs and provide support for hinge points for pivoting arms and elastic members.

In some embodiments, a palatal layer is used as a reinforced central platform around TADs and can be used as the material for flexible arms that are torsion resistant for mesial and distal tooth movement.

In some embodiments, a palatal layer can be used as a reinforced central platform around TADs and can be used as a material for flexible arms that are formed over computer generated guides to increase their strength. The computer-generated guides may be formed on the model by the software and can have multiple cross-sections.

In some embodiments, buccal support layers may be added to increase appliance stiffness to enhance the ability of the appliance to intrude incisor teeth.

In some embodiments, buccal support layers may be added as supports for rotational axles to support inter-arch appliances.

In some embodiments, lingual support structures may be added to both upper and lower appliances to help control molar tipping, to prevent molar tipping, and to help control changes in posterior arch width. These lingual structures may be used to prevent molar tipping in the case where intrusion appliance arms are placed on the buccal side of the teeth.

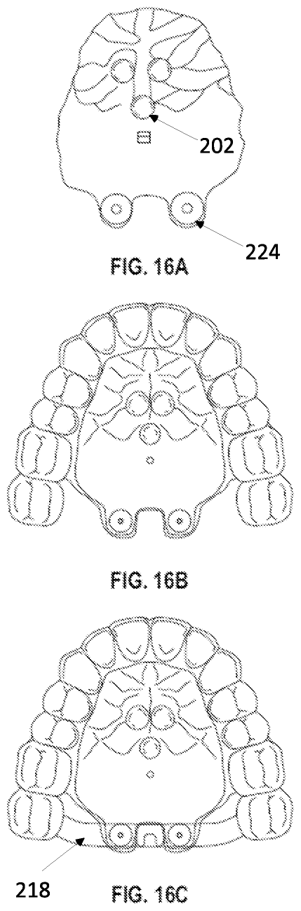

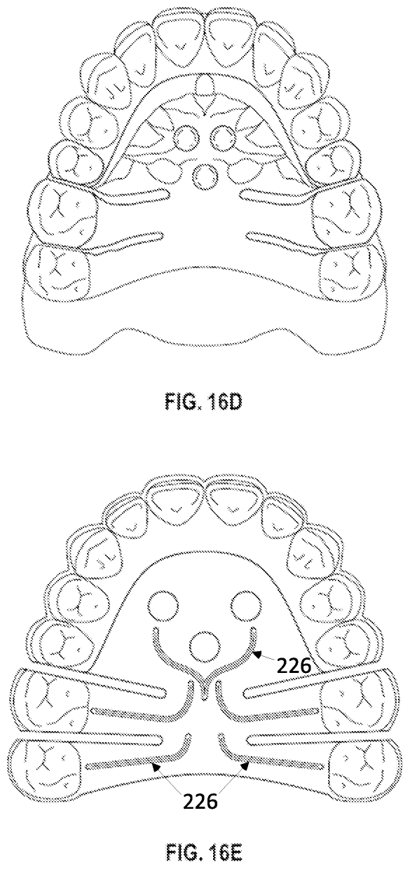

FIG. 16A shows an embodiment of a 3-D printed palatal covering layer to be used as a reinforcing layer for an aligner. It has three recesses 202 formed to engage the three simulated TAD's that were placed in the “safe” zone in the “T” formation in the anterior palate. Along the posterior border it has two support locations 224 for hinge points to support pivoting arms for molar distalizing purposes.

FIG. 16B shows the same 3-D printed palatal covering layer of FIG. 16A with a thermoformed clear plastic layer that has been formed over the top of it. This view would be an intermediate construction step in the fabrication of an example appliance with pivoting distalizing arms.

FIG. 16C is a modification of the same picture shown in FIG. 16B. Lines have been added to show where the distalizing arms would be installed. The second molar teeth of this appliance would have to be sectioned free from the remainder of the teeth to allow distal movement of the second molars to take place as the arms 218 are activated by the use of an elastic band as shown in FIG. 13B. Some embodiments of this appliance are entirely 3-D printed, including the movable arms, which could be printed in place.

FIG. 16D is the same picture as FIG. 14A of a palatal layer can be used as a central supporting platform and can also be used as one of two layers to help form stronger active arms (stronger than one layer would be alone, and with greater torque resistance) for moving teeth in a mesial and distal direction.

FIG. 16E is the same picture as in FIG. 14B showing the 2-layer appliance with stronger active arms, but also with the addition of ridges or 3-dimensional elevated structures formed by having computer generated guides added to the surface of the palate of the model by the software to increase the strength of the arms. These ridges 226 in the drawing are also shown around the three TAD recesses to provide a little more rigidity in this area. The placement of the ridges 226 is not limited to the areas shown only in the drawing. Other placements could also be used should they prove to be beneficial for enhancing the properties of the aligner appliance and would still fall within the scope of the claimed invention. Various example cross-sections for the guides were shown earlier in FIG. 9B. These guide cross-sections are not the only options. Other suitable shapes are also possible.

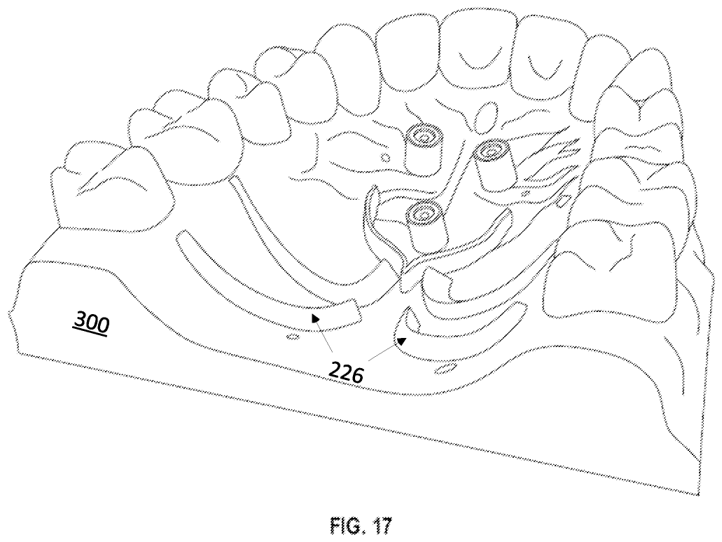

FIG. 17 is a schematic diagram of a dental model 300 with three cylindrical TAD analogues positioned in the palate. This dental model may be used, for example, in the process of fabricating a thermoformed aligner. In some implementations, the TAD analogues have spherical heads as has been described previously. This model also includes ridges 226 to guide the formation of reinforcing structures (as described previously) during thermoforming. Additionally, the model includes holes to minimize air being trapped and preventing thermoforming to the TAD structures.

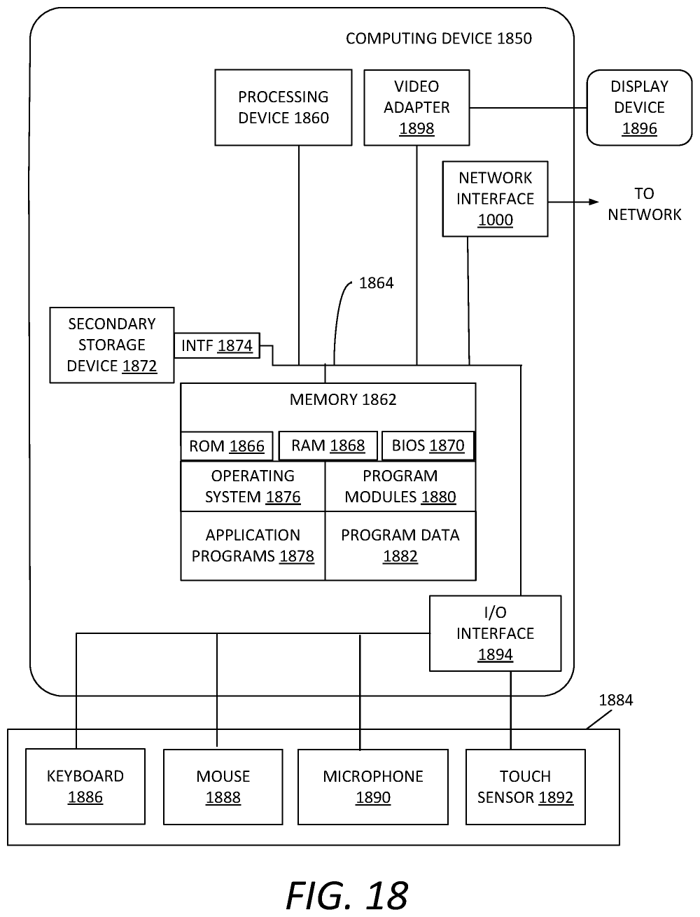

FIG. 18 illustrates an example architecture of a computing device 950 that can be used to implement aspects of the present disclosure, including methods of planning treatments, designing thin-shell aligners, fabricating thin-shell aligners, placing attachments segments on digital representations of thin-shell aligners, and generating digital representations of dental models for fabrication with rapid prototyping technology. For example, the computer device may be used to design an aligner or a series of aligners that include at least some of the functionality described herein.

The computing device 950 illustrated in FIG. 18 can be used to execute the operating system, application programs, and software modules (including any software engines) described herein.

The computing device 950 includes, in some embodiments, at least one processing device 960, such as a central processing unit (CPU). A variety of processing devices are available from a variety of manufacturers, for example, Intel or Advanced Micro Devices. In this example, the computing device 950 also includes a system memory 962, and a system bus 964 that couples various system components including the system memory 962 to the processing device 960. The system bus 964 is one of any number of types of bus structures including a memory bus, or memory controller; a peripheral bus; and a local bus using any of a variety of bus architectures.

Examples of computing devices suitable for the computing device 950 include a desktop computer, a laptop computer, a tablet computer, a mobile computing device (such as a smart phone, an iPod® or iPad® mobile digital device, or other mobile devices), or other devices configured to process digital instructions.

The system memory 962 includes read only memory 966 and random access memory 968. A basic input/output system 970 containing the basic routines that act to transfer information within computing device 950, such as during start up, is typically stored in the read only memory 966.

The computing device 950 also includes a secondary storage device 972 in some embodiments, such as a hard disk drive, for storing digital data. The secondary storage device 972 is connected to the system bus 964 by a secondary storage interface 974. The secondary storage devices 972 and their associated computer readable media provide nonvolatile storage of computer readable instructions (including application programs and program modules), data structures, and other data for the computing device 950.

Although the example environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory computer-readable media. Additionally, such computer readable storage media can include local storage or cloud-based storage.

A number of program modules can be stored in secondary storage device 972 or system memory 962, including an operating system 976, one or more application programs 978, other program modules 980 (such as the software engines described herein), and program data 982. The computing device 950 can utilize any suitable operating system, such as Microsoft Windows™, Google Chrome™ OS or Android, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 950 through one or more input devices 984. Examples of input devices 984 include a keyboard 986, mouse 988, microphone 990, and touch sensor 992 (such as a touchpad or touch sensitive display). Other embodiments include other input devices 984. The input devices are often connected to the processing device 960 through an input/output interface 994 that is coupled to the system bus 964. These input devices 984 can be connected by any number of input/output interfaces, such as a parallel port, serial port, game port, or a universal serial bus. Wireless communication between input devices and the interface 994 is possible as well, and includes infrared, BLUETOOTH® wireless technology, 802.11a/b/g/n, cellular, ultra-wideband (UWB), ZigBee, or other radio frequency communication systems in some possible embodiments.

In this example embodiment, a display device 996, such as a monitor, liquid crystal display device, projector, or touch sensitive display device, is also connected to the system bus 964 via an interface, such as a video adapter 998. In addition to the display device 996, the computing device 950 can include various other peripheral devices (not shown), such as speakers or a printer.

When used in a local area networking environment or a wide area networking environment (such as the Internet), the computing device 950 is typically connected to the network through a network interface 1000, such as an Ethernet interface or WiFi interface. Other possible embodiments use other communication devices. For example, some embodiments of the computing device 950 include a modem for communicating across the network.

The computing device 950 typically includes at least some form of computer readable media. Computer readable media includes any available media that can be accessed by the computing device 950. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 950.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 18 is also an example of programmable electronics, which may include one or more such computing devices, and when multiple computing devices are included, such computing devices can be coupled together with a suitable data communication network so as to collectively perform the various functions, methods, or operations disclosed herein.

It will be appreciated that the present disclosure may include any one and up to all of the following examples.

Example 1. A dental appliance comprising: a unibody aligner having a top surface and a bottom surface, the unibody aligner comprising: an alignment portion shaped to fit over multiple teeth of a patient, the alignment portion having a buccal side and a lingual side; and a palatal portion integrally formed with the lingual side of the alignment portion, the palatal portion including one or more retention sockets, each of the one or more retention sockets shaped for fitment over an implanted temporary anchorage device (TAD).

Example 2. The dental appliance of Example 1, wherein a top surface of the palatal portion has contours to line up with contours of the patient's palate.

Example 3. The dental appliance of any one of Examples 1-2, wherein the one or more retention sockets have a partial recessed surface.

Example 4. The dental appliance of any one of Examples 1-3, wherein the one or more retention sockets are shaped to removably attach with a head of the implanted TAD.

Example 5. The dental appliance of any one of Examples 1-4, wherein the implanted TAD has a spherical head and the recessed surface has a spherical shape.

Example 6. The dental appliance of any one of Examples 1-5, wherein the implanted TAD has a head and the recessed surface has a shape of any one of a sphere, cylinder, ellipsoid, ovoid and pyriform.

Example 7. The dental appliance of any one of Examples 1-6, wherein the palatal portion includes at least two retention sockets.

Example 8. The dental appliance of any one of Examples 1-7, further comprising: two or more palatal arms extending from the palatal portion, the palatal arms having a proximal end and a distal end, the proximal end being integrally formed with the palatal portion, and the distal end shaped to fit over a tooth of the patient.

Example 9. The dental appliance of any one of Examples 1-8, further comprising:

two or more palatal arms extending from the palatal portion, the palatal arms having a proximal end and a distal end, the proximal end being hingedly connected to the palatal portion, and the distal end shaped to fit over a tooth of the patient.

Example 10. The dental appliance of any one of Examples 1-9, wherein the two or more palatal arms are made from the same material as the unibody aligner.

Example 11. The dental appliance of any one of Examples 1-10, further comprising: two or more connectors extending from the palatal portion, the connectors having a proximal end and a distal end, the proximal end being connected to the palatal portion, and the distal end being connected to a single tooth aligner.

Example 12. The dental appliance of any one of Examples 1-11, further comprising a loop-shaped connector integrally formed with the alignment portion and a single tooth-aligner.

Example 13. The dental appliance of any one of Examples 1-12, further comprising: wherein the two or more connectors are looped-shaped metal wires, and the single tooth aligner is made from the same material as the unibody aligner.

Example 14. The dental appliance of any one of Examples 1-13, wherein an elongate unfilled space extends between the distal end and the proximal end of the palatal arms and an edge of the palatal portion.

Example 15. The dental appliance of any one of Examples 1-14, comprising reinforcing structures integrally formed in the palatal portion.

Example 16. The dental appliance of any one of Examples 1-15, comprising one or more metal spacers the palatal portion has a thickness greater than thickness of the alignment portion.

Example 17. The dental appliance of any one of Examples 1-16, comprising metallic, longitudinal reinforcing structures disposed along the buccal side.

Example 18. The dental appliance of any one of Examples 1-17, comprising one or more double loops wires positioned in between sections of the buccal side.

Example 19. A dental appliance comprising: an alignment portion shaped to fit over multiple teeth of a patient, the alignment portion having a buccal side and a lingual side; and

the buccal side having integrally formed portions configured to fit over an implant.

Example 20. The dental appliance of Example 20, where the implant comprises any one of a temporary anchorage device (TAD), a bone plate and a bone plate attachment tube.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A dental appliance comprising:
a unibody aligner having a top surface and a bottom surface, the unibody aligner comprising:
an alignment portion shaped to fit over multiple teeth of a patient, the alignment portion having a buccal side and a lingual side; and
a palatal portion integrally formed with the lingual side of the alignment portion, the palatal portion including one or more retention sockets, each of the one or more retention sockets shaped for fitment over an implanted temporary anchorage device (TAD).

2. The dental appliance of claim 1, wherein a top surface of the palatal portion has contours to line up with contours of the patient's palate.

3. The dental appliance of claim 1, wherein the one or more retention sockets have a partial recessed surface.

4. The dental appliance of claim 3, wherein the one or more retention sockets are shaped to removably attach with a head of the implanted TAD.

5. The dental appliance of claim 4, wherein the implanted TAD has a spherical head and the recessed surface has a spherical shape.

6. The dental appliance of claim 4, wherein the implanted TAD has a head and the recessed surface has a shape of any one of a sphere, cylinder, ellipsoid, ovoid and pyriform.

7. The dental appliance of claim 3, wherein the palatal portion includes at least two retention sockets.

8. The dental appliance of claim 1, further comprising:
two or more palatal arms extending from the palatal portion, the palatal arms having a proximal end and a distal end, the proximal end being integrally formed with the palatal portion, and the distal end shaped to fit over a tooth of the patient.

9. The dental appliance of claim 1, further comprising:
two or more palatal arms extending from the palatal portion, the palatal arms having a proximal end and a distal end, the proximal end being hingedly connected to the palatal portion, and the distal end shaped to fit over a tooth of the patient.

10. The dental appliance of claim 9, wherein the two or more palatal arms are made from the same material as the unibody aligner.

11. The dental appliance of claim 1, further comprising:
two or more connectors extending from the palatal portion, the connectors having a proximal end and a distal end, the proximal end being connected to the palatal portion, and the distal end being connected to a single tooth aligner.

12. The dental appliance of claim 11, further comprising a loop-shaped connector integrally formed with the alignment portion and a single tooth-aligner.

13. The dental appliance of claim 11, wherein the two or more connectors are looped-shaped metal wires, and the single tooth aligner is made from the same material as the unibody aligner.

14. The dental appliance of claim 7, wherein an elongate unfilled space extends between the distal end and the proximal end of the palatal arms and an edge of the palatal portion.

15. The dental appliance of claim 1, comprising reinforcing structures integrally formed in the palatal portion.

16. The dental appliance of claim 1, comprising one or more metal spacers the palatal portion has a thickness greater than thickness of the alignment portion.

17. The dental appliance of claim 1, comprising metallic, longitudinal reinforcing structures disposed along the buccal side.

18. The dental application of claim 1, comprising one or more double loops wires positioned in between sections of the buccal side.

19. A dental appliance comprising:
an alignment portion shaped to fit over multiple teeth of a patient, the alignment portion having a buccal side and a lingual side; and
the buccal side having integrally formed portions configured to fit over an implant.

20. The dental appliance of claim 20, where the implant comprises any one of a
temporary anchorage device (TAD), a bone plate and a bone plate attachment tube.
